(19) United States
(12) Patent Application Publication
(10) Pub. No.: US 2016/0348422 A1
(43) Pub. Date: Dec. 1, 2016

(54) JOINT SEALS FOR FLEXIBLE WALL PANELS

(71) Applicant: Ryan Withrow, Platteville, WI (US)

(72) Inventor: Ryan Withrow, Platteville, WI (US)

(21) Appl. No.: 14/722,458

(22) Filed: May 27, 2015

(51) Int. Cl. E06B 7/16; E06B 3/46

(52) U.S. Cl. CPC E06B 7/16; E06B 3/4636

(57) ABSTRACT

Example room dividers are disclosed herein. An example room divider includes a first panel and a second panel. A first seal between the first panel and the second panel is to provide a first line of contact with at least one of the first panel or the second panel. A second seal between the first panel and the second panel is to provide a second line of contact with at least one of the first panel or the second panel. A touch-and-hold fastener connects the first panel and the second panel. The touch-and-hold fastener is positioned between the first line of contact and the second line of contact.

### FIELD OF THE DISCLOSURE

This patent generally pertains to flexible room dividers and, more specifically, to joint seals for flexible wall panels.

### BACKGROUND

Some room dividers are comprised of a series of semi-flexible curtains that are suspended from an overhead structure and are interconnected along their vertical edges by hook-and-loop fasteners. Such room divider assemblies provide a relatively quick, easy, and affordable way for separating interior spaces having different environmental requirements or for isolating spaces from dust, paint overspray, odors, and/or other airborne contaminants.

Insulation may be added to the curtains of the room dividers to reduce heat migration within a building and help maintain a desired air temperature and/or humidity within designated areas. Such areas are often used for storing refrigerated or frozen foods and/or other perishable goods.

Some room dividers are made of curtains having special qualities for certain purposes. For example, some curtains have acoustic insulation for noise absorption, impenetrable strength for security, and/or flame resistance for limiting the spread of smoke and fire.

### BRIEF DESCRIPTION OF THE DRAWINGS

FIG. 1 is a front view of an example room divider constructed in accordance with the teachings disclosed herein.

FIG. 2 is a cross-sectional exploded view corresponding to FIG. 4.

FIG. 3 is a cross-sectional assembly view corresponding to FIG. 4.

FIG. 4 is a cross-sectional view taken along line 4-4 of FIG. 1.

FIG. 5 is a cross-sectional exploded view similar to FIG. 2 but showing another example room divider constructed in accordance with the teachings disclosed herein.

FIG. 6 is a cross-sectional assembly view similar to FIG. 3 but showing the example room divider of FIG. 5.

FIG. 7 is a cross-sectional view similar to FIG. 4 but showing the example room divider of FIG. 5.

### DETAILED DESCRIPTION

Example room dividers disclosed herein include a plurality of flexible panels interconnected along vertical edges by, for example, fasteners (e.g., touch-and-hold fasteners, VELCRO®). Vertically elongate seals on either side of each fastener shelter the fastener from heat. The adjoining interlocking faces of the fasteners create an interface that is air permeable. In some examples, the seals disclosed herein may prevent air and/or airborne contaminants from passing through the interface provided by the interlocking faces of the fasteners. In some examples, the seals are hollow and have an internal loop that urges the seal toward an adjacent panel.

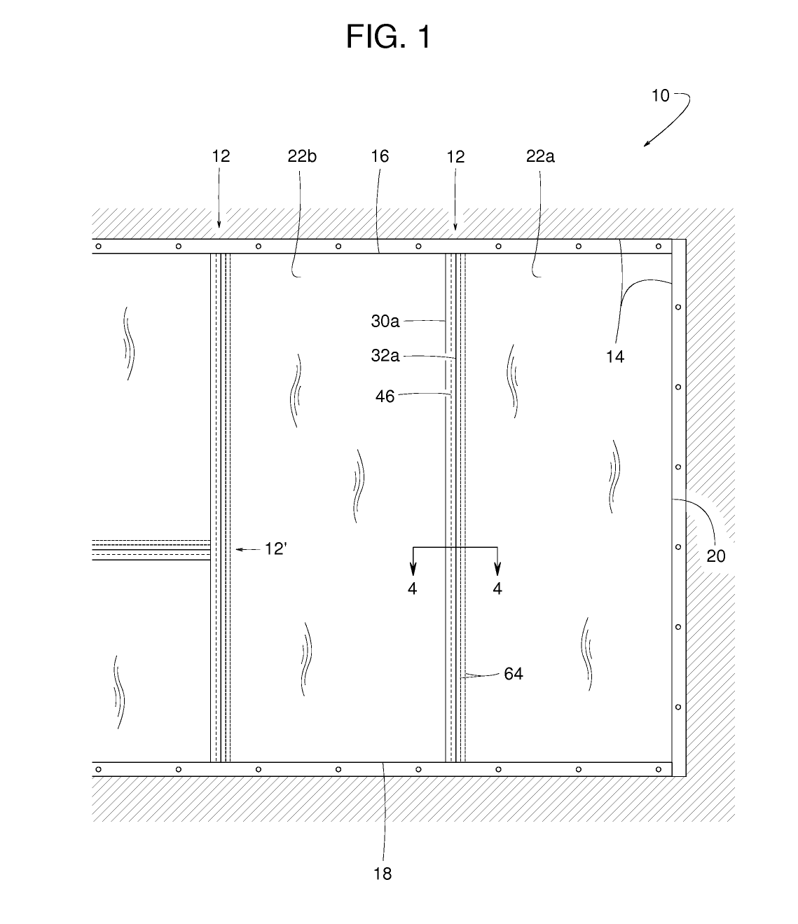

FIGS. 1-4 show an example room divider 10 (divider assembly) having (e.g., two or more) panels that are interconnected along a first joint 12 (e.g., a vertical joint) and/or a second joint 12′ (e.g., a horizontal joint) to provide a divider assembly for use, for example, within a building 14. The divider assembly's upper edge 16, lower edge 18 and/or lateral edges 20 can be fastened to a ceiling, wall, floor and/or structural features of building 14 by any suitable means (e.g., screws, overhead hangers, mounting track, angle iron, channel, bar, cable, clips, hooks, clamps and various combinations thereof). The room divider 10 is useable for various purposes, examples of which include, but are not limited to, separating two areas within a building; blocking off a hallway leading to a certain area; isolating spaces from dust, paint overspray, odors and/or other contaminants; and/or creating a blast freezer or cold storage room next to a warmer area within a building. In some examples, the room divider 10 is thermally insulated and/or heat resistant.

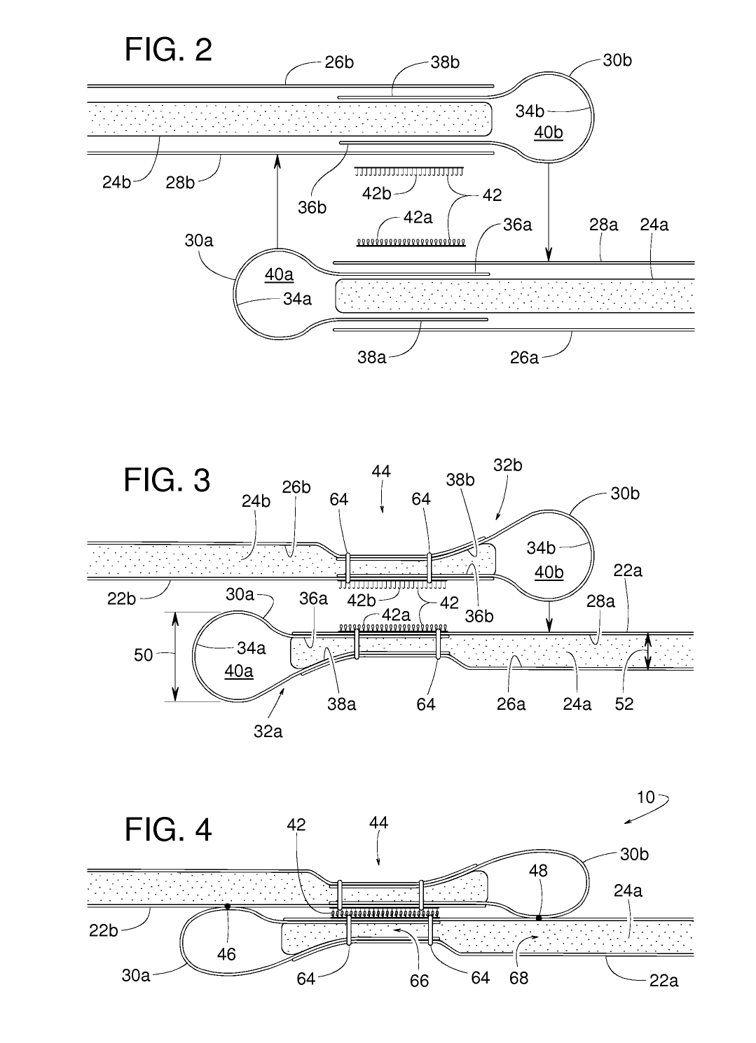

Referring to FIGS. 2-4, the example of room divider 10 of the illustrated example includes a first panel 22a connected or coupled to a second panel 22b. In this example, the first panel 22a includes a first core 24a sandwiched between a first outer sheet 26a and a first connecting sheet 28a. The first core 24a of the illustrated example is lightweight (due to its low density), pliable, compressible and resilient, which makes first panel 22a easy to handle, sew, install and/or ship. Example materials of the first core 24a include, but are not limited to, open-cell foam, closed-cell foam, polyester batting and carbon fiber batting. Such materials can provide thermal insulation and/or heat resistance. Example materials of the sheets 26a and 28a include, but are not limited to, plastic sheeting, heat resistant sheeting, coated fabric, uncoated fabric, single-layer sheeting, multilayer sheeting, and/or various combinations thereof. In some examples, the sheets 26a and 28a are made of vinyl coated polyester, which is pliable and lightweight (due to its relative thinness). Such material qualities further help in making first panel 22a easy to handle, sew, install and/or ship. Example couplings, fasteners and/or means for connecting the first outer sheet 26a and the first connecting sheet 28a include, but are not limited to, sewing, thermal welding, adhesive bonding and/or any other suitable fastener(s).

In the example shown in FIGS. 2-4, a first seal 30a extends along a first edge 32a of the first panel 22a. In this example, the first seal 30a is in the shape of a channel including a first web 34a extending between a first connecting flange 36a and a first outer flange 38a. The first connecting flange 36a connects or couples to the first connecting sheet 28a, and the first outer flange 38a connects or couples to the first outer sheet 26a. The first web 34a is spaced apart from the panel's first edge 32a to create a first air chamber 40a between the first web 34a and the first edge 32a. The first seal 30a of the illustrated example has a channel shape and contains and/or defines the first air chamber 40a. The first seal 30a and/or the first air chamber 40a provides a conforming resilient seal against the adjoining second panel 22b and helps protect a less heat resistant touch-and-hold fastener 42 that connects or couples the panels 22a and 22b.

In some examples, to provide the first seal 30a with a desired level of stiffness and durability, the seal 30a is made of the same material of the sheets 26a and 28a and has a thickness that is greater than a thickness of the sheet 26a and/or the sheet 28a. In some examples, the first seal 30a and the sheets 26a and 28a have the same material thickness. In some examples, the first outer flange 38a is an integral extension of the first outer sheet 26a, where the first seal 30a and the first outer sheet 26a is a unitary piece or structure. In some examples, the first connecting flange 36a is an integral extension of the first connecting sheet 28a, where the first seal 30a and the first connecting sheet 28a is a unitary piece or structure. In some examples, the first seal 30a is an integral extension of the sheets 26a and 28a. For greater heat resistance, example materials of the first seal 30a include, but are not limited to, silicone impregnated fiberglass, chlorosulfonated polyethylene (CSPE) synthetic rubber (CSM), and/or HYPALON sheeting (HYPALON is a registered trademark of DuPont).

In some examples, the panels 22a and 22b are substantially similar or identical, particularly in the area where the panels 22a and 22b connect or couple to each other. More specifically, the second panel 22b includes a second core 24b, a second outer sheet 26b, a second connecting sheet 28b and a second edge 32b. The second core 24b, the second outer sheet 26b, the second connecting sheet 28b and/or the second edge 32b respectively correspond and/or are similar in structure (e.g., are identical) to the respective first core 24a, the first outer sheet 26a, the first connecting sheet 28a and the first edge 32a. For example, a second seal 30b of the second panel 22b is substantially similar or identical in structure to the first seal 30a. The second seal 30b includes a second web 34b, a second outer flange 38b, a second connecting flange 36b and a second air chamber 40b. The second web 34b, the second outer flange 38b, the second connecting flange 36b and the second air chamber 40b respectively correspond and/or are substantially similar in structure (e.g., identical) to the respective first web 34a, the first outer flange 38a, the first connecting flange 36a and the first air chamber 40a.

To connect or couple the second panel 22b to the first panel 22a, a first strip 42a of touch-and-hold fastener 42 is sewn, bonded and/or otherwise attached (attached directly or indirectly) to the first connecting sheet 28a proximate the first edge 32a of the first panel 22a. Likewise, a second strip 42b of touch-and-hold fastener 42 is sewn, bonded and/or otherwise attached (attached directly or indirectly) to the second connecting sheet 28b proximate the second edge 32b of the second panel 22b. When brought together, the strips 42a and 42b matingly interlock or couple in a manner known to those of ordinary skill in the art of touch-and-hold fasteners. The term, “touch-and-hold fastener” described herein refers to an assembly of two strips of material having a broad distribution of elements that releasably interlock when facing surfaces of the strips engage. In some examples, the strips accommodate extensive misalignment in a direction parallel to the facing surfaces of the strips. An example touch-and-hold fastener is a VELCRO® hook-and-loop fastener (VELCRO® is a registered trademark of Velcro Industries). In some examples, touch-and-hold fastener 42 is installed or positioned at or adjacent an overlapping area 44 of the panels 22a and 22b. The overlapping area 44 increases (e.g., maximizes) joint strength and seal integrity between the panels 22a and 22b. In some examples, the width of the overlapping area 44 is approximately equal to the width of the touch-and-hold fastener 42.

In some instances, some known touch-and-hold fasteners have a low tolerance to heat and may not provide an air-tight seal between the interlocking faces. For example, cold or warm air may flow sideways between the strips 42a and 42b of touch-and-hold fastener 42 causing frost along the joint and/or heat loss across the interlocking faces. Airflow through strips of touch-and-hold fastener 42 might also convey airborne contaminants between two areas otherwise separated by the room divider. For cost advantages, some examples of touch-and-hold fastener 42 provide less heat resistant than the seals 30a and 30b, the sheets 26a, 26b, 28a and 28b, and/or cores 24a and 24b.

To overcome the air permeability and/or low heat resistance of the touch-and-hold fastener 42, the seals 30a and 30b shelter, trap or isolate the touch-and-hold fastener 42 between a first sealing line of contact 46 (established by the first seal 30a engaging the second panel 22b) and a second sealing line of contact 48 (established by the second seal 30b engaging the first panel 22a), as shown in FIG. 4. To ensure the continuity of contact lines 46 and 48, each of the seals 30a and 30b expanded channel-shape and internal air chamber provides a collapsible chamber or bubble (e.g., a bubble-like effect) that helps each seal 30a and 30b to conform to the contour of the respective seal-engaged panel 22b and 22a while providing sufficient seal-to-panel sealing pressure to inhibit frost and/or heat loss along the interlocking faces of the touch and hold fastener 42. In some examples, adequate sealing is achieved by providing the seals 30a and 30b with a seal thickness 50 that is greater than an average thickness 52 of the panels 22a and 22b.

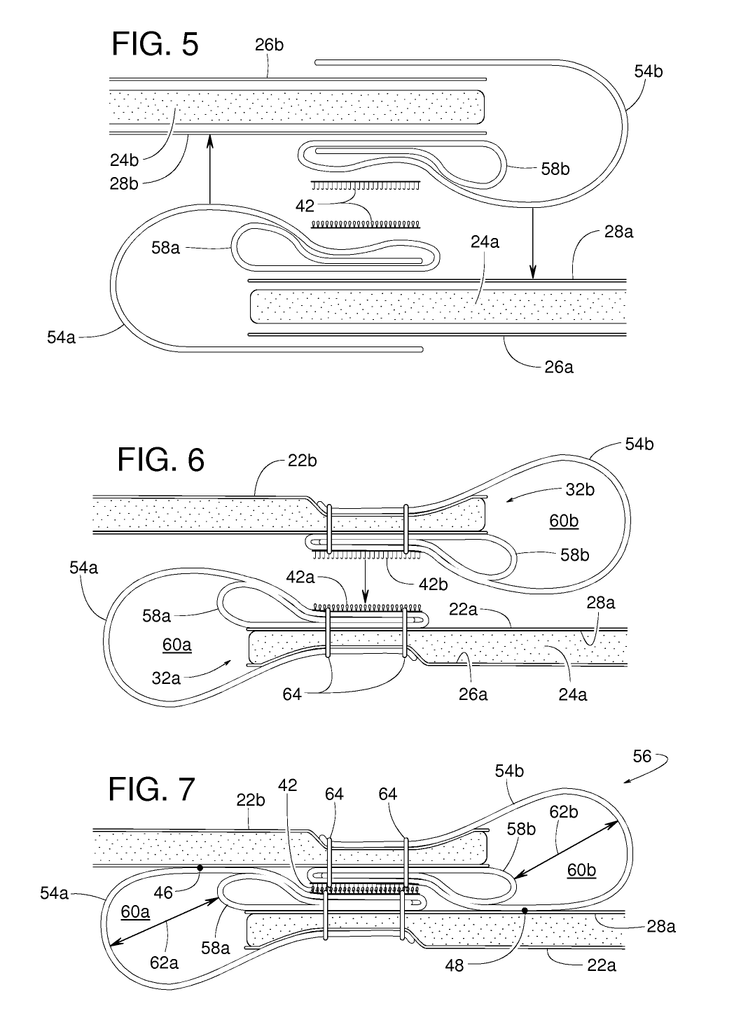

To provide greater seal-to-panel sealing pressure, example seals 54a and 54b of an example room divider 56 shown in FIGS. 5-7 include internal loops 58a and 58b that urge an exterior portion of the seals 54a and 54b toward the respective panels 22b and 22a to which the seals 54a and 54b press against and/or engage. More specifically, the first seal 54a contains the first loop 58a inside a first air chamber 60a of the first seal 54a. The first loop 58a and the first seal 54a define an air gap 62a between the first loop 58a and the first seal 54a. The air gap 62a provides a collapsible chamber or bubble (e.g., a bubble-like effect). In some examples, the first loop 58a is made of the same material as the first seal 54a. In some examples, the first loop 58a is made of the same material as the first connecting sheet 28a. In the illustrated example, the first loop 58a is an integral extension of the first seal 54a, where the first loop 58a and the first seal 54a are a unitary piece of material or structure. In some examples, the second seal 54b is substantially equivalent to the first seal 54a. For example, the second seal 54b includes a second loop 58b corresponding and/or substantially similar to the first seal 54a and the first loop 58a, respectively.

In some examples, a heat resistant thread provides a threaded seam 64 that attaches the strips 42a and 42b to their respective panels 22a and 22b, attaches the seals 30a, 30b, 54a and 54b to their respective panels 22a and 22b; and/or pinches the panel's edges (e.g., edges 32a and 32b). Pinching the edges 32a and 32b causes the cores 24a and 24b to be more dense along the edges and less likely to burn or become damaged when exposed to (e.g., high) heat. More specifically, in the example of FIGS. 2-4, the first core 24a is denser in a first area 66 proximate the first seal 30a than at a second area 68 that is spaced apart from the first area 66.

For further clarification, it should be noted that the term, “pliable” refers to a material that can be readily folded over onto itself and later unfolded and/or restored to its original shape without appreciable damage to the material. The term, “heat resistant” is a measure of a material's temperature at which it begins to melt, burn and/or become damaged due to heat. The term, “unitary” refers to a single piece that is seamless.

Although certain example methods, apparatus and articles of manufacture have been described herein, the scope of the coverage of this patent is not limited thereto. On the contrary, this patent covers all methods, apparatus and articles of manufacture fairly falling within the scope of the appended claims either literally or under the doctrine of equivalents.

1. A room divider, comprising:
a first panel;
a second panel;
a first seal attached to a first edge of the first panel, the first seal extending from the first edge to provide a first line of contact with at least one of the first panel or the second panel;
a second seal attached to a second edge of the second panel, the second seal extending from the second edge to provide a second line of contact with at least one of the first panel or the second panel; and
a touch-and-hold fastener to connect the first panel and the second panel, the touch-and-hold fastener being positioned between the first line of contact of the first seal and the second line of contact of the second seal, the first seal and the second seal to shelter the touch-and-hold fastener between the first line of contact and the second line of contact to restrict air flow through the touch-and-hold fastener.

2. The room divider of claim 1, wherein the first line of contact, the second line of contact and the touch-and-hold fastener are vertically elongate.

3. The room divider of claim 1, wherein the first line of contact is between the first seal and the second panel, and the second line of contact is between the second seal and the first panel.

4. The room divider of claim 1, wherein the first panel and the second panel are pliable and resilient.

5. The room divider of claim 1, wherein the first seal and the second seal are more heat resistant than the touch-and-hold fastener.

6. The room divider of claim 1, wherein the first panel comprises a core that is more dense in a first area proximate the first seal than at a second area that is spaced apart from the first area.

7. The room divider of claim 1, wherein the first seal has a channel shape defining a first air chamber between the first seal and the first panel.

8. The room divider of claim 7, further comprising a first loop inside the first air chamber of the first seal, the first loop and the first seal defining an air gap between the first loop and the first seal.

9. The room divider of claim 8, wherein the first loop comprises an integral extension of the first seal such that the first loop and the first seal are a unitary piece of material.

10. A room divider, comprising:
a first panel;
a second panel to overlap the first panel to provide an overlapping area between the first panel and the second panel;
a first seal attached to a first edge of the first panel, the first seal to extend from the first edge of the first panel to engage the second panel along a first line of contact;
a second seal attached to a second edge of the second panel, the second seal to extend from the second panel to engage the first panel along a second line of contact; and
a touch-and-hold fastener positioned between the first panel and the second panel at the overlapping area, the touch-and-hold fastener being positioned between the first line of contact and the second line of contact, and the first seal and the second seal being more heat resistant than the touch-and-hold fastener.

11. The room divider of claim 10, wherein the first panel and the second panel are pliable and resilient.

12. The room divider of claim 10, wherein the first line of contact, the second line of contact and the touch-and-hold fastener are vertically elongate.

13. The room divider of claim 10, wherein the first panel comprises a core that is more dense in a first area proximate the touch-and-hold fastener than at a second area that is proximate the second line of contact.

14. The room divider of claim 10, wherein the first seal comprises a channel shape to define a first air chamber between the first seal and the first panel.

15. The room divider of claim 14, further comprising a first loop inside the first air chamber of the first seal, the first loop and the first seal defining an air gap between the first loop and the first seal.

16. The room divider of claim 15, wherein the first loop is an integral extension of the first seal such that the first loop and the first seal comprise a unitary piece of material.

17. A room divider, comprising:
a first panel including a first outer sheet, a first connecting sheet and a first core positioned between the first outer sheet and the first connecting sheet, the first panel having a first edge that is vertically elongate;
a first seal extending along the first edge of the first panel, the first seal having a channel shape, the first seal including a first web, a first connecting flange and a first outer flange, the first web to extend between the first connecting flange and the first outer flange, the first connecting flange being attached to the first connecting sheet, the first outer flange being attached to the first outer sheet, the first web being spaced apart from the first edge of the first seal to define a first air chamber defined by the first web, the first connecting flange, the first outer flange and the first edge of the first panel;
a second panel including a second outer sheet, a second connecting sheet and a second core positioned between the second outer sheet and the second connecting sheet, the second panel having a second edge that is vertically elongate;
a second seal attached to the second edge of the second panel, the second seal having channel shape, the second seal including a second web, a second connecting flange and a second outer flange, the second web to extend between the second connecting flange and the second outer flange, the second connecting flange being attached to the second connecting sheet, the second outer flange being attached to the second outer sheet, the second web being spaced apart from the second edge of the second seal to define a second air chamber defined by the second web, the second connecting flange, the second outer flange and the second edge of the second panel; and
a touch-and-hold fastener including a first strip and a second strip, the first strip attachable to the first connecting sheet proximate the first edge of the first panel, the second strip attachable to the second connecting sheet proximate the second edge of the second panel, the first strip being removably attachable to the second strip, the first outer sheet and the second outer sheet facing in substantially opposite directions, the first seal to engage the second connecting sheet along a first line of contact, the second seal to engage the first connecting sheet along a second line of contact, the touch-and-hold fastener being interposed between the first line of contact and the second line of contact.

18. The room divider of claim 17, wherein the first connecting flange of the first seal is spaced apart from the second connecting sheet of the second panel, and the second connecting flange of the second seal is spaced apart from the first connecting sheet of the first panel.

19. The room divider of claim 17, wherein the touch-and-hold fastener is interposed between the first connecting flange of the first seal and the second connecting flange of the second seal.

20. The room divider of claim 17, wherein the first seal and the second seal are more heat resistant than the touch-and-hold fastener.

21. The room divider of claim 17, wherein the first seal, the second seal, the first outer sheet, the second outer sheet, the first connecting sheet, the second connecting sheet, the first core and the second core each are more heat resistant than the touch-and-hold fastener.

22. The room divider of claim 17, further comprising a threaded seam joining the first strip, the first connecting sheet, the first connecting flange, the first core, the first outer flange and the first outer sheet.

23. The room divider of claim 17, wherein the first core is more dense in a first area between the first connecting flange and the first outer flange than at a second area spaced farther away from the first seal.

24. The room divider of claim 17, wherein the first seal has a seal material thickness, the first outer sheet has a sheet material thickness, the seal material thickness is greater than the sheet material thickness, the first seal and the first outer sheet being substantially equivalent in material composition.

25. The room divider of claim 17, further comprising a first loop inside the first air chamber of the first seal, the first loop and the first seal defining an air gap between the first loop and the first seal.

26. The room divider of claim 25, wherein the first loop is an integral extension of the first seal such that the first loop and the first seal comprise a unitary piece of material.

27. The room divider of claim 17, wherein the first connecting sheet and the first outer sheet comprise a pliable sheet material.

28. The room divider of claim 17, wherein the first core comprises a pliable and resiliently compressible material.

29. The room divider of claim 17, wherein the first connecting flange is directly attached to the first connecting sheet and the first outer flange is directly attached to the first outer sheet.

30. The room divider of claim 17, wherein the first connecting flange is positioned between the core and the first connecting sheet.

31. The room divider of claim 30, wherein the first outer flange is positioned between the core and the first outer sheet.
